(19) United States
(12) Patent Application Publication
(10) Pub. No.: US 2011/0218678 A1
(43) Pub. Date: Sep. 8, 2011

(54) Systems and Methods for Mixing a Solution

(76) Inventor: Kurt Sebben, San Jose, CA (US)

(21) Appl. No.: 12/718,860

(22) Filed: Mar. 5, 2010

(51) Int. Cl. G05B 19/43; B01F 15/04; G05D 11/02

(52) U.S. Cl. 700/265; 366/162.1; 366/152.1; 366/163.2; 700/285

(57) ABSTRACT

A chemical mixing method to safely mix a dry chemical into a solution provides a mixing process with high levels of precision and accuracy. Water may be pumped into a mixing tank through a Venturi tube, which creates a vacuum that may be used to withdraw the dry chemical from the shipping container. The eductor system including the Venturi tube may be thoroughly flushed before the mixing process is finalized, and the effluent from the flushing procedure may be pumped to the mixing tank to recover all measured dry chemical and water.

### CROSS-REFERENCE TO RELATED APPLICATIONS

This application is related to Applicant's co-pending U.S. patent application Ser. No. 12/718,797, filed Mar. 5, 2010, incorporated herein by reference in its entirety.

### BACKGROUND OF THE INVENTION

1. Field of the Invention

The present invention generally relates to chemical handling systems. The present invention more specifically relates to a method for mixing an aqueous solution.

2. Description of the Related Art

Liquid chemical solutions are used in many manufacturing processes. A typical solution is formed by mixing a dry chemical with a solvent such as water. The current state of the art methodology of preparing such solutions is to put the dry chemical into an appropriate receptacle and then add water. The measurements of the dry chemical and the water are generally performed manually.

The prior art methods are subject to several drawbacks. The manual measuring and handling of the materials leads to some inaccuracy in the composition of the final solution. Moreover, in many solutions, the components are toxic or carcinogenic, therefore making direct handling by the operator unsafe.

Manual mixing also leads to quantity limitations. With manual mixing, quantities produced are limited by the speed and manual dexterity of the people doing the mixing. Another drawback is that because manual mixing processes generally must be performed by a third party vendor, the product solutions must be purchased only in commercially available quantities. This can lead to waste if a given operation is not set up to use exactly the quantities available for purchase.

Obtaining chemical supplies from third party suppliers may require that large quantities of hazardous chemicals be stored on site in order to ensure that production will not be interrupted. The storage may require multiple storage tanks and the need to adjust chemical deliveries to accommodate changes in production schedules. Multiple storage tanks may require local hazmat approval because they represent a danger to the environment and emergency response people should an accident occur. Additionally, if a facility does not have enough built-in hazardous storage capacity, production may be shut down due to insufficient storage capacity even with daily shipments from third parties.

Finally, the cost of a solution prepared with a manual mixing process is relatively high. Manual mixing processes must typically be carried out either by trained technicians or by scientists. The per unit cost of the product solution is therefore unnecessarily high.

There is, therefore, a need in the art for a system that can accurately and precisely mix a dry chemical and a solvent into a solution.

### SUMMARY OF THE CLAIMED INVENTION

An exemplary embodiment of the invention is a chemical mixing method designed to safely mix a dry chemical into a solution, typically an aqueous solution. The method is a mixing process that results in much higher levels of accuracy and precision than can be achieved through mixing the chemicals by currently known methods, which makes the method ideal for many industrial applications. By implementing the method, manufacturers are able to prepare in-house the aqueous solutions required for their production applications. The in-house production enables the manufacturer to produce the required aqueous solutions at a significantly reduced cost per unit, and in quantities only as necessary to exactly meet production volume requirements.

The method is initiated by pumping a predetermined amount of solvent into a mixing tank. The solvent will typically be water. The operator of the system activates a pump to pump solvent through an eductor Venturi tube. The flow of solvent through the eductor Venturi tube creates a vacuum in an eductor vacuum line. The solvent may be returned to the mixing tank and recirculated.

The operator may then use an eductor wand connected to the eductor vacuum line to siphon the dry chemical into the mixing tank using the vacuum line of the eductor. The operator carefully weighs the dry chemical before and after siphoning so he knows exactly how much dry chemical has been introduced to the solution.

As the dry chemical is vacuumed into the solution, the concentration of chemical suspended in solvent increases gradually over time. Mixing dry chemicals with solvents may create or absorb heat. A slow rate of mixing allows for control of exothermic and or endothermic reactions caused by the mixing action. The slow rate also allows for the addition or dissipation of heat so that chemical temperature tolerances are not exceeded. A solution that is too cold or too hot may ruin the effect the chemical is intended to have on a production process.

Following siphoning, the operator places the eductor wand into a top off/rinse tank. Dry chemical residue that may be on the eductor wand or vacuum line is rinsed off by pumping solvent into the top off/rinse tank, with enough solvent being pumped into the top off/rinse tank to cover at least a portion of the vacuum line. The effluent rinsed solution may then be pumped from the top off/rinse tank to the mixing tank to ensure that all measured dry chemical and solvent is included in the resultant solution.

The rinsing process may be repeated as necessary to ensure that that the desired concentration is achieved and no residual matter remains in the eductor wand or vacuum line. The contents of the mixing tank may be cycled through the eductor Venturi tube and back to the mixing tank as many times as may be necessary to ensure thorough mixing of the solution. The resulting vacuum may be used to dry the eductor wand and vacuum line to improve accuracy of successive batches. Additionally, when dry chemicals are being mixed with solvent, the eductor wand and vacuum line must be dry in order to prevent clogging.

In solutions requiring high accuracy of mixture, a flow meter may be used to measure a flow rate of the solvent flowing into the mixing tank. The flow meter may include a paddle wheel. The paddle wheel generates pulses that are monitored by the computer control used to control the operation of the method. Using a paddle wheel generating 180 pulses per second, the error of measurement for the solvent introduced into the solution may be less than 0.0005 percent.

The eductor wand, vacuum line, and the rinse tank may be cleared using a purge mechanism. The purge mechanism introduces a fluid which may be under pressure. Various fluids may be used in the purge mechanism. Nitrogen and clean dry air have been found to be effective fluids for use in the purge mechanism.

### BRIEF DESCRIPTION OF THE DRAWINGS

FIG. 1 illustrates a schematic process of the presently disclosed mixing system.

FIG. 2 illustrates a mixing method utilizing the system of FIG. 1.

### DETAILED DESCRIPTION

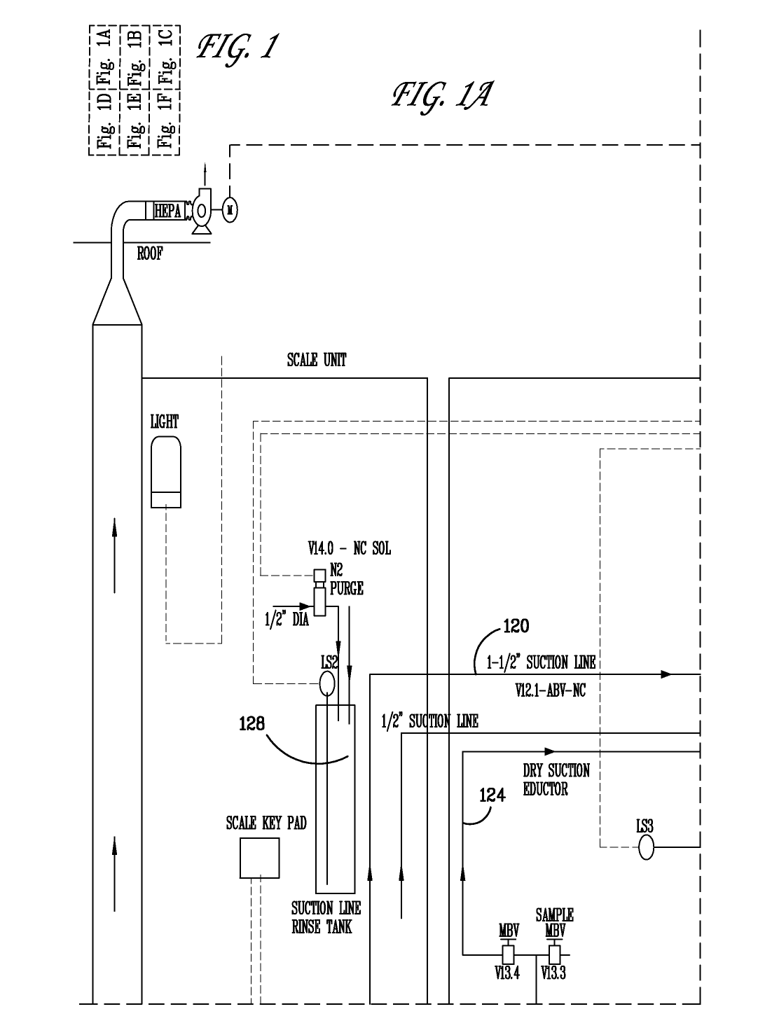

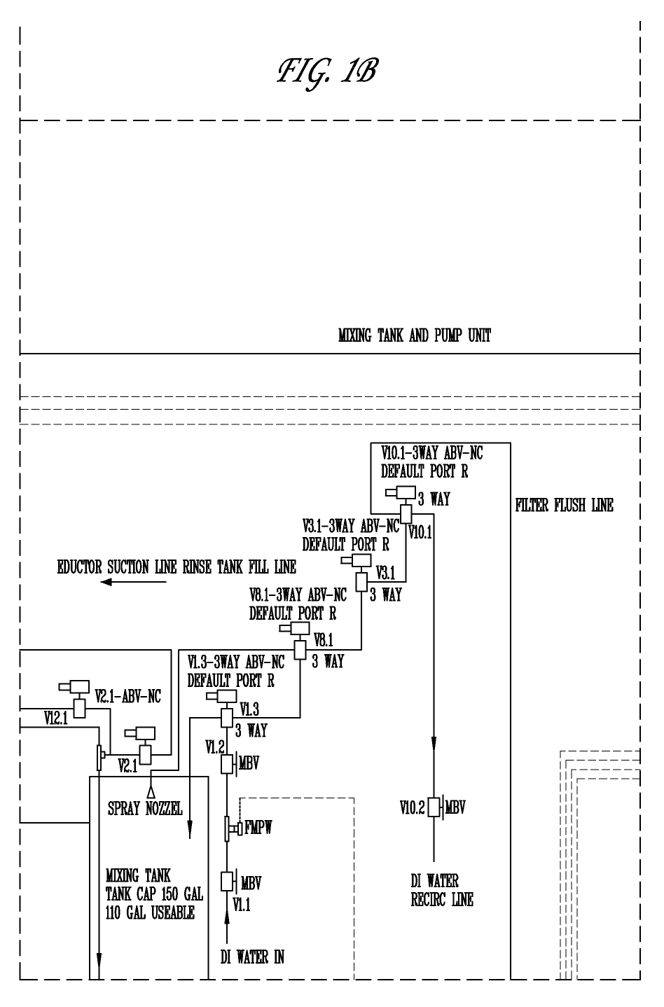

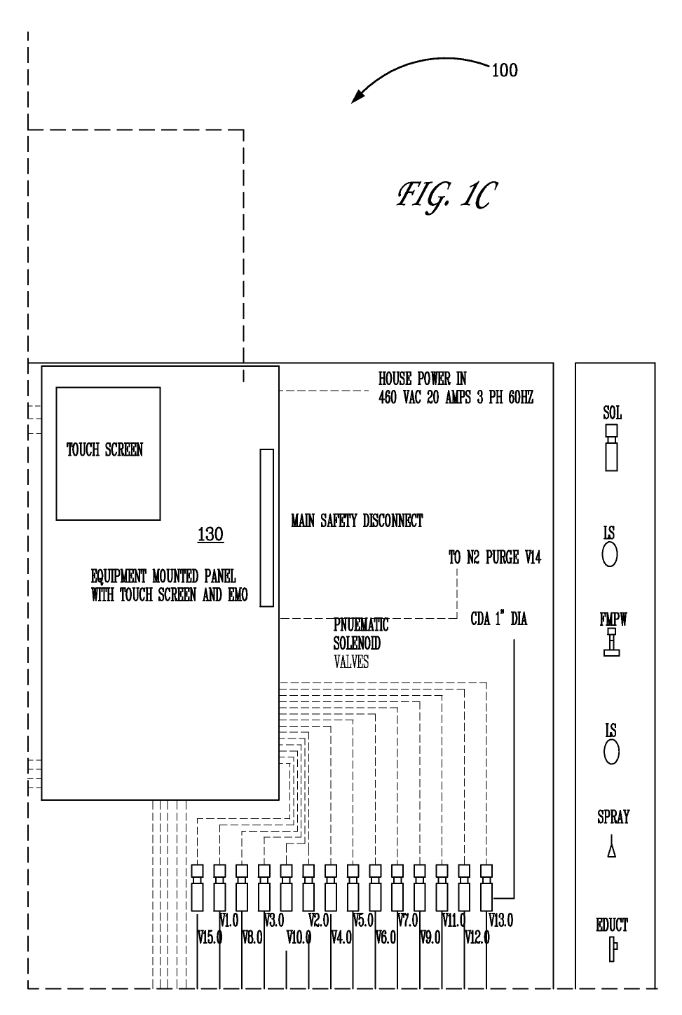

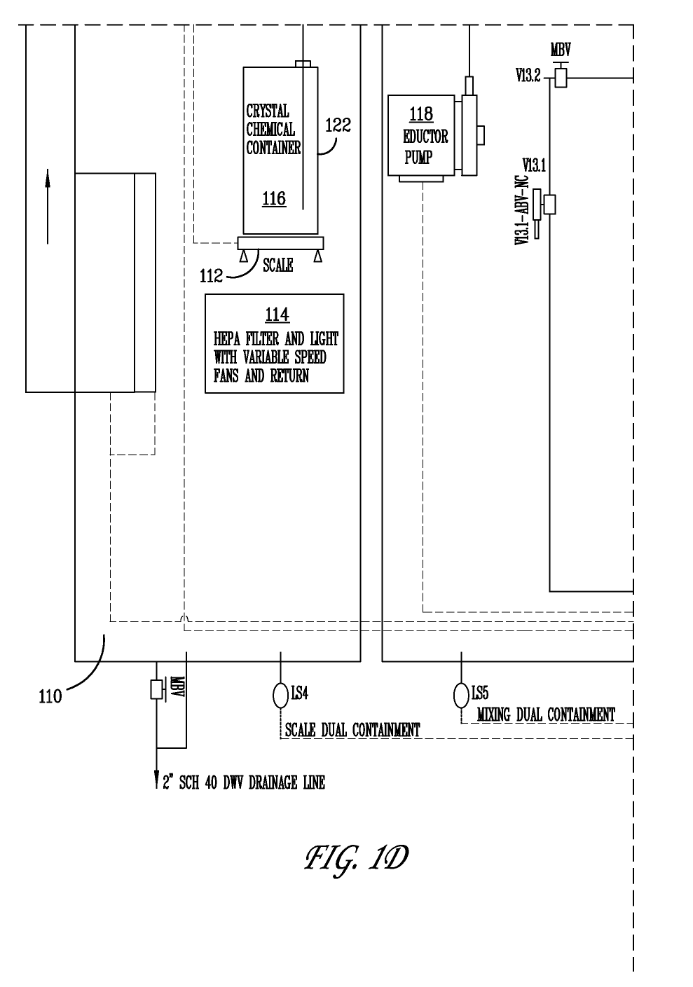

FIG. 1 illustrates a mixing system 100 that may safely mix a dry crystalline or powdered chemical with a liquid to form an aqueous solution. A main processing area of the system 100 of FIG. 1 includes a dry chemical dispensing area 110. The dry chemical dispensing area 110 may include a precision scale 112 to facilitate accurate measurement of the dry chemical that is to be mixed into solution.

It should be noted that although the system is chiefly described herein with reference to using de-ionized water as the solvent, other solvents can be employed according to the desired composition of the resultant solution. It also should be noted that although the system is chiefly described herein with reference to mixing dry powders, slurries and liquids may be employed.

Many of the chemicals that are employed in the system 100 are toxic and/or caustic. To protect the operator, the dry chemical dispensing area 110 may be surrounded by a full containment safety enclosure that may include hepa filtration elements 114. The safety enclosure provides the operator with a means of protection from airborne chemical powders and contaminants. To ensure that the filtration elements 114 are functioning properly, the system 100 may monitor the pressure differential across any present filtration elements 114. If the pressure differential exceeds a preselected level, the system 100 may be disabled and the operator notified that the filtration elements 114 require service.

As another safety element, to ensure that no spills are uncontained, both the chemical dispensing area 110 and the mixing and pumping areas may be contained in a stainless steel or polypropylene open top tank with a bottom drain.

Through the use of system 100, the operator may withdraw the dry chemical from the chemical container 116 without coming into physical contact with the chemicals. The dry chemical may be transported to the dispensing area 110 in a sealed chemical container 116. The mixing system may include an eductor located in the dry chemical dispensing area 110. The eductor may include an eductor pump 118, a vacuum line 120, an eductor wand 122 that may be attached to a terminal end of the vacuum line 120, and a Venturi tube 124. The eductor wand 122 of FIG. 1 allows the operator to withdraw dry chemicals from the container 118 without having to come into physical contact with the chemicals.

When the eductor pump 118 is activated, water is pumped through the Venturi tube 124 into a mixing tank 126. The water flow through the Venturi tube 124 creates a vacuum in the vacuum line 120. The operator may, after opening the chemical container 118, siphon the dry chemical into the mixing tank 126 using the suction from the eductor wand 122. The operator may simply insert the eductor wand 122 into the chemical container 116 and the dry chemical is siphoned through the vacuum line 120 into the mixing tank 126.

The precision scale 112 may be used by the operator to ensure that the correct amount of dry chemical is transferred to the mixing tank 126. Various sizes of the mixing tank 126 may be employed, depending on the batch size to be mixed.

Water may be pumped into the mixing tank 126 by the eductor. The volume of water pumped into the mixing tank 126 by the eductor can be measured with a computer controlled in-line flow meter installed in a section of eductor piping in which the flow of water is a laminar flow. The flow meter may be of the paddle wheel type, utilizing a plurality of impellers that activate a make-or-break magnetic switch. The flow meter may be adapted to measure up to 180 pulses per second. (Various embodiments may utilize flow meters with greater or fewer pulses per second.) Using this precise measurement of the flow rate, a K factor (calculation constant) may be derived to calculate the actual volume of water that flows into the mixing tank 126.

Derivation of the K factor may include taking into account an applicable Reynolds number to account for frictional losses and the diameter of the eductor piping. The flow rate and time are measured, and the total volume of water that is pumped into the mixing tank 126 can then be easily calculated. In practice, during the set-up period of the system, physical measurements of the volume of liquid in the mixing tank 126 may be compared to the calculated volume. The K factor can then be adjusted if necessary to refine the volume calculation. Using this method, the volume control in the system has proven to be accurate to within 2 ml in a 150 gallon batch, or less than a 0.0004 percent error.

A top off/rinse tank 128 may also be provided in the dry chemical dispensing area 110. After the operator has siphoned the proper amount of dry chemical from the chemical container 116, the operator may place the eductor wand 122 in the top off/rinse tank 128. The wand 122 may be rinsed and the vacuum line 120 flushed so that any residual dry chemical or solvent is pumped into the mixing tank 126.

In order to ensure complete evacuation of the system following the rinse operation, the eductor may be flushed in a fluid purge operation. Typically, nitrogen or clean dry air (CDA) will be used as the fluid for the purging operation, although other fluids may be chosen by the user depending on the circumstances of a given application.

For the fluid purge operation, an outlet for a purging fluid tank may be positioned above the top off/rinse tank 128. When a valve of the purging fluid tank is opened, the fluid flows downward through the top off/rinse tank 128, and then through the piping of the eductor. In order to ensure that the fluid purge completely cleanses the eductor, the valve used in the eductor may include fluid access ways that enable the fluid to pass through any dead spots in the interior of the valve, thereby removing any residual matter remaining in the valve. A valve that may be used in the eductor is described in further detail in Applicant's co-pending U.S. patent application Ser. No. 12/718,797, and is previously incorporated herein.

For ease of operation and control, valves utilized in the system 100 may be selected to be pneumatic solenoid valves. Operation of the valves may be controlled by a computer control panel 130 which may include a touch screen control. The control panel 130 may also include means to control the pumps, motors, and other devices used in the system.

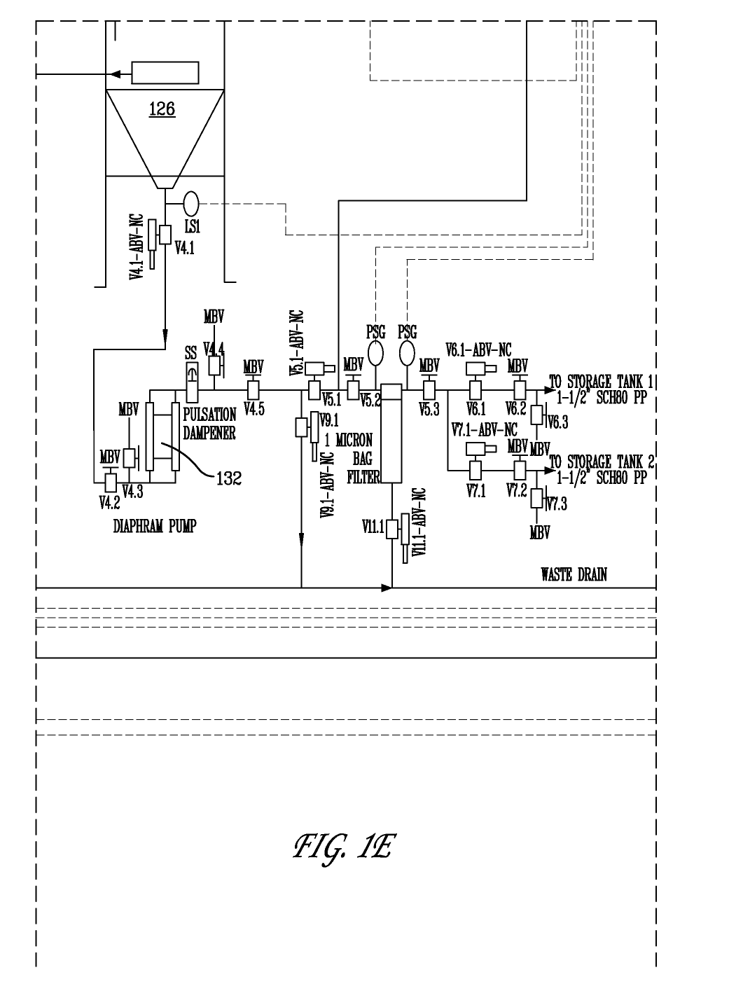

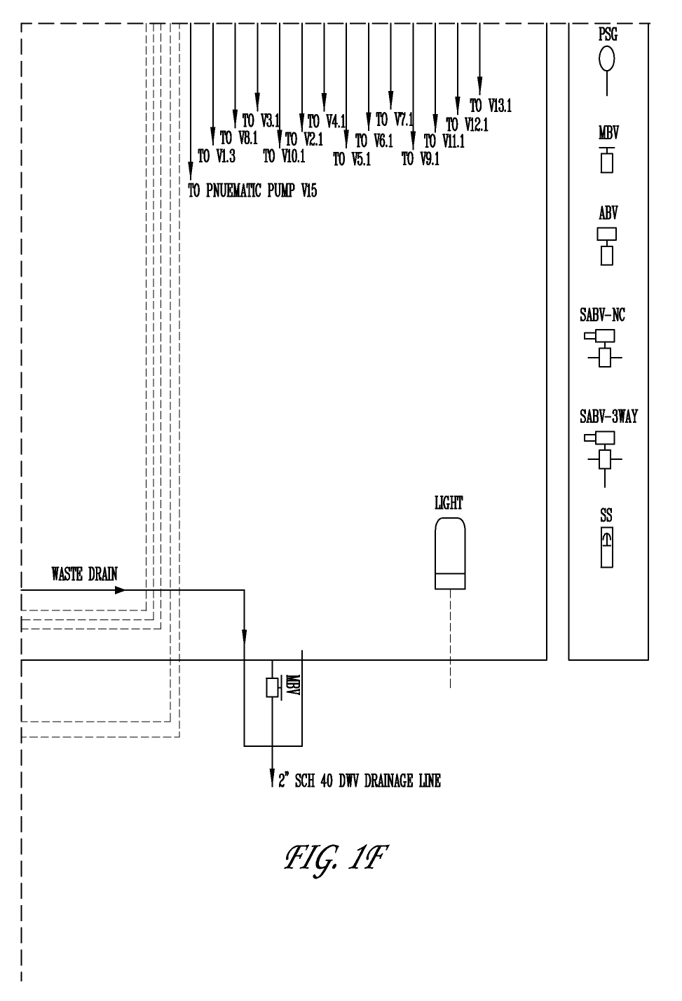

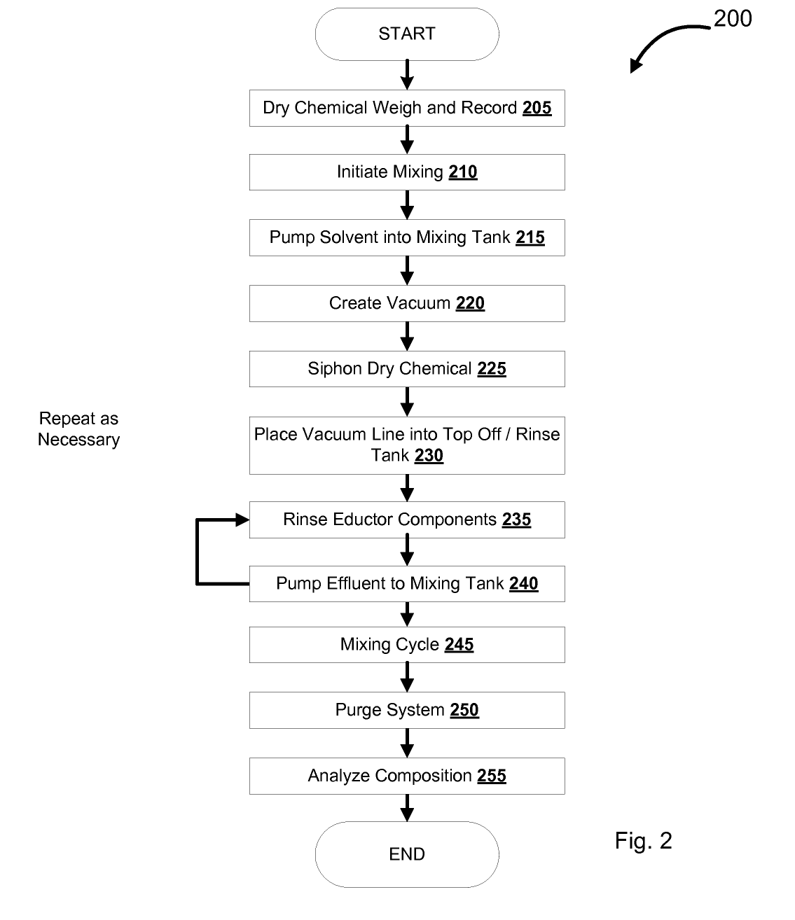

FIG. 2 illustrates a mixing method 200 utilizing the system of FIG. 1. The method 200 begins with a weighing and recording step 205. The operator may begin the mixing process 200 by placing the dry chemical container 116 on the precision scale 112 in the dry chemical dispensing area 110. The container 116 may be kept sealed at this point. The total weight of the container 116 and the dry chemical to be mixed, the chemical held in container 116, may be recorded so that the operator can later determine how much of the chemical has been removed from the container 116 to be placed into the solution that is the product of the process 100.

The operator may execute an initiate mixing step 210 to proceed with the mixing process by pressing a “make a batch” button on the touch screen of the control panel 130. A fan associated with the hepa filter 114 may be ramped up to full speed, thereby ventilating the dispensing area 110. The operator is then advised that it is safe to open the dry powder chemical container 116.

Actuation of the “make a batch” button on the control panel 130 triggers a pump solvent step 215. In this step, a transfer pump 132 may be actuated and a fill valve opened, causing water to begin to flow into the mixing tank 126. The flow meter may very accurately measure the amount of water that is pumped into the mixing tank 126. The fill valve remains open until a predetermined volume of water, defined by the specific batch operation, has been pumped into the mixing tank 126.

When the designated volume of water has been pumped into the mixing tank 126, the system closes the fill valve, and the operator may be prompted to acknowledge completion of the pump solvent step of the mixing process.

The operator may be prompted to initiate a vacuum creation step 220. The operator begins the vacuum creation step 220 may be initiated by pressing a “start the eductor pump” button on the computer control panel 130. When the eductor activation step 220 has been initiated, the eductor pump 118 draws water from the mixing tank 126 and pumps the water through the eductor Venturi tube 124 and then back to the mixing tank 126. The flow of water through the eductor Venturi tube 124 eventually creates a vacuum that may be used to siphon material from the dry chemical container 116 into the mixing tank 126 later in the process. As water flows through the Venturi tube 124, pressure on a valve to the vacuum line 120 increases. When the pressure reaches an appropriate level, 60 psi for example, the valve may be opened and a vacuum may be created in the vacuum line 120 of the eductor.

When the vacuum has been established in the vacuum line 120, the operator may remove the eductor wand 122 from the top off/rinse tank 128 and begin a dry chemical siphon step 225. In this step, the dry chemical is siphoned from the container 116. The operator continues to siphon the dry chemical from the container 116 until the desired amount of dry chemical has been removed. The operator may measure the quantity of dry chemical that is pumped out of the chemical container 116 by monitoring the weight change with the precision scale 112 and recording the quantity.

When a correct amount of the dry chemical has been pumped, the operator may place the eductor wand 122 back into the top off/rinse tank 128 in a place vacuum line into top off/rinse tank step 230. The operator may then press a continue button on the computer control panel 130 to continue the mixing process.

As the mixing process continues, the operator may enter the amount of water required to bring the solution to the proper concentration. From the measurements of the flow meter, the operator knows how much water has been pumped into the mixing tank 126, and from the recorded weights, how much dry chemical has been added. The operator can therefore calculate the volume of additional water required to bring the solution to the correct concentration. A pre-calculated chart may be provided to the operator to facilitate the determination of the required volume of water. Once the number of top off gallons of water has been determined, the operator may enter the number of gallons required into the control panel 130 via the touch screen. The operator may be required to confirm the top off quantity before the system will allow additional water to be pumped.

When the operator has entered the required top off quantity into the system via the control panel 130, an eductor valve may be closed so that water may be pumped into the top off/rinse tank 128 to begin rinsing eductor components in step 235. As water flows into the top off/rinse tank 128, the volume is monitored with the flow meter. The water level in the top off/rinse tank 128 may rise until most of the eductor wand 122, particularly including any area of the eductor wand 122 that might have been exposed to the dry chemical, is submerged to rinse the eductor wand 122 and the vacuum line 120.

The system monitors a water level in the top off/rinse tank 128 and pumps effluent to the mixing tank in step 240. When the system determines that the water level has reached a predetermined fill point, the eductor valve may be opened so that the effluent rinsed solution in the top off/rinse tank 128 is pumped from the top off/rinse tank 128 to the mixing tank 126. When a sufficient volume of solution has been pumped from the top off/rinse tank 128 to reduce the water level to a predetermined low level set point, the eductor valve may be closed, and step 235 may be repeated. Depending on the required top off volume for a given solution concentration, the rinsing of eductor components in step 235 may be repeated several times. When the programmed required top off volume of water is reached, a fill valve to the top off/rinse tank 124 is automatically closed.

During a mixing cycle 245, which may be timed, the eductor pump 118 continues to run to circulate the solution through the system. A timer may trigger audible and/or visual signals to indicate the end of the mixing cycle. After the timer has expired, the eductor pump 118 may be turned off.

In step 250, the system is purged to flush any residual matter from the eductor with a fluid purge. A fluid valve above the top off/rinse tank 128 may be opened, allowing fluid to flow downward through the top off/rinse tank 128 and through the eductor vacuum line 120. The fluid may dry the inside of the vacuum line 120. In addition, the fluid may carry any residual solution into the mixing tank 126.

In a confirm composition step 255, the operator takes a sample of the solution batch for analysis to confirm the composition of the solution. Following analysis of the batch the operator may be given at least three alternatives: (1) add more dry chemical powder if the chemical concentration is too low, (2) add additional de-ionized water if the chemical concentration is too high, or (3) transfer the solution to a storage tank.

If the concentration of the subject chemical in the batch is found to be too low, the operator will add an amount of dry chemical calculated to bring the batch to the desired concentration. If the chemical concentration is found to be too high, a calculated volume of water will be added to the solution. After addition of either dry chemical or water, the operator will repeat the mixing 245 and purge 250 cycles.

When a batch is found to be within required parameters, the operator may select the “transfer the batch” batch option. The operator may be given the option to transfer the batch to either a storage tank or to drain. There may be multiple storage tanks available to the operator. In typical embodiments of the system, two storage tanks are used, tank A and tank B. If the “transfer to tank A” option is selected by the operator, the tank A discharge valve may be opened, transfer pump 132 started, and the solution pumped into tank A. This process may continue until either the mixing tank 126 is empty, or storage tank A is full. If the system receives a signal that storage tank A is full, the pumping process may be automatically stopped and the operator alerted. The operator may then be given the option to transfer the solution from the mixing tank 126 to storage tank B or to drain.

If both storage tanks are full, the only options available to the operator may be to hold the solution in the mixing tank 122 or to transfer to drain. The option to transfer to drain would typically be used only in the event the batch was found to be defective for some reason, and could not be salvaged.

The embodiments described herein are illustrative of the present invention. As these embodiments of the present invention are described with reference to illustrations, various modifications or adaptations of the methods and or specific structures described may become apparent to those skilled in the art in light of the descriptions and illustrations herein. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method of mixing a dry chemical with a solvent to form a solution, the method comprising:
pumping a predetermined amount of solvent into a mixing tank;
pumping the solvent through a Venturi tube, thereby creating a vacuum in an eductor vacuum line;
siphoning the dry chemical into the mixing tank using the eductor vacuum line;
rinsing dry chemical residue from the vacuum line by pumping solvent into a top off/rinse tank containing at least a portion of the vacuum line, the solvent pumped into the top off/rinse tank covering at least a portion of the vacuum line; and
returning an effluent solution from the top off/rinse tank to the mixing tank.

2. The method of claim 1, further comprising repeating rinsing of the dry chemical residue to result in a predetermined concentration of the resultant solution.

3. The method of claim 1, further comprising cycling contents of the mixing tank through the eductor Venturi tube and back to the mixing tank to thoroughly mix the contents of the mixing tank.

4. The method of claim 1 further comprising measuring a flow rate of solvent flowing into the mixing tank, the measurement taking place at a flow meter in the line.

5. The method of claim 4, wherein a computer control of the method monitors the flow meter output via pulses from a paddle wheel of the flow meter, the flow meter using a paddle wheel to generate 180 pulses per second.

6. The method of claim 4, wherein the flow meter measures the flow rate with an error of less than 0.0005 percent.

7. The method of claim 1, further comprising clearing the vacuum line and the rinse tank of residual matter during a fluid purge cycle.

8. The method of claim 7, wherein the vacuum line and rinse tank are cleared using nitrogen.

9. The method of claim 7, wherein the vacuum line and rinse tank are cleared using clean dry air (CDA).

10. The method of claim 7, wherein effluent fluid from the fluid purge cycle flows to the mixing tank to ensure that all material introduced into the liquid flow line is included with the solution.

11. A system to mix a dry chemical with a solvent to form a solution, the system comprising:
an eductor pump;
a Venturi tube;
a vacuum line, the eductor pump pumping the solvent through the Venturi tube, flow of the solvent through the Venturi tube creating a vacuum in the vacuum line of the eductor;
a mixing tank in which the dry chemical is mixed with the solvent; and
a transfer pump to pump the solvent into the mixing tank and the solution out of the mixing tank.

12. The system of claim 11, further comprising a flow meter to measure a flow rate of solvent flowing into the mixing tank.

13. The system of claim 12, wherein the flow meter includes a paddle wheel that generates 180 pulses per second.

14. The system of claim 11, further comprising a computer control for the system, the computer control monitoring an output of a flow meter.

15. The system of claim 11 further comprising a rinse tank that is at least partially filled with solvent, a portion of the vacuum line that contacts the dry chemical being submerged in the rinse tank, the solvent removing any residual dry chemical remaining in the vacuum line, and the effluent solution flowing to the mixing tank.

16. The system of claim 15, further comprising a fluid purge mechanism to purge and dry the vacuum line and the rinse tank.

17. The system of claim 16, wherein the fluid purge mechanism introduces nitrogen into the system.

18. The system of claim 16, wherein the fluid purge mechanism introduces clean dry air into the system.

19. The system of claim 16, wherein the fluid purge mechanism introduces fluid under pressure into the system.

20. The system of claim 16, wherein an outlet port of the fluid purge mechanism is in fluid communication with the mixing tank to ensure that all material introduced into the liquid flow line is included with the solution.
